(19) United States
(12) Patent Application Publication
(10) Pub. No.: US 2026/0223786 A1
(43) Pub. Date: Aug. 6, 2026

(54) MULTI-CHANNEL LIGHTBULB AND BAR-TYPE LIGHTING LAMP FOR CROP GROWTH

(71) Applicant: ODYSSEYGLOBAL CO., LTD., Gwangju (KR)

(72) Inventor: Jong Hyun JUNG, Gwangju (KR)

(73) Assignee: ODYSSEYGLOBAL CO., LTD., Gwangju (KR)

(21) Appl. No.: 19/159,070

(22) PCT Filed: Feb. 24, 2023
(86) PCT No.: PCT/KR2023/002652

§ 371 Date: Aug. 22, 2025

(30) Foreign Application Priority Data
Feb. 24, 2023 (KR) 10-2023-0024923

(51) Int. Cl. A01G 7/04; F21S 4/24; F21S 4/28; F21V 7/28; F21V 29/67; F21Y 103/10; F21Y 103/30; F21Y 115/10

(52) U.S. Cl. CPC A01G 7/045; F21S 4/24; F21S 4/28; F21V 7/28; F21V 29/67; F21Y 2103/10; F21Y 2103/30; F21Y 2115/10

(57) ABSTRACT

The present invention relates to a multi-channel bulb and bar-type lighting lamp for crop growth, which may include a body provided with a predetermined installation region, a lighting unit provided with a substrate installed in the installation region of the body and a plurality of LED groups mounted on the substrate and generating light having different wavelength ranges, a power supply unit coupled to the body to supply power to the lighting unit and connected to an external power source, and a control module configured to operate at least one LED group selected by an operator among the LED groups, wherein the substrate may extend by a predetermined length, may be configured such that LED chips included in the LED groups are sequentially arranged thereon in a longitudinal direction, and may be formed to be curved according to the installation region.

### TECHNICAL FIELD

The present invention relates to a multi-channel bulb and bar-type lighting lamp for crop growth, and more particularly, to a multi-channel bulb and bar-type lighting lamp for crop growth provided with a plurality of LED groups outputting light having different wavelength ranges.

### BACKGROUND ART

In general, a light emitting diode (LED) is a device that emits light when electrons and holes are recombined at a P-N semiconductor junction by application of current, is typically manufactured in a structure of a package having an LED chip mounted therein, and is commonly referred to as an “LED package”.

The LED package is generally mounted on a printed circuit board (PCB, hereinafter referred to as “PCB”), is configured to emit light by receiving current applied from an electrode formed on the PCB, and a lamp using the LED package has advantages of lower power consumption, longer lifetime, and eco-friendliness compared with conventional lamps.

LED lighting as described above has been continuously researched for popularization due to its excellent characteristics such as superior vibration resistance, high reliability, and low power consumption, and unlike a conventional glass bulb-type light source, is a solid-state point light source that is rigid, and although having very small light output per unit, is robust so that a plurality thereof may be arranged to be manufactured into a lamp having a desired output, and currently, the lighting field using LEDs is rapidly growing and is expected to be applied and used in all industrial fields and daily life as a next-generation light source.

However, in the case of lighting in which a conventional LED package is applied, since a plurality of LED chips that generate light of the same wavelength range are provided, there is a disadvantage in that it is difficult to apply to crop cultivation such as a smart farm that requires providing light of various wavelength ranges depending on crop growth.

### DISCLOSURE

### Technical Problem

The present invention has been devised to improve the above-described problems, and the present invention is directed to providing a multi-channel bulb and bar-type lighting lamp for crop growth, which is provided with a plurality of LED groups emitting light of various wavelength ranges to provide light of various wavelengths according to crop cultivation conditions.

### Technical Solution

A multi-channel bulb and bar-type lighting lamp for crop growth according to the present invention to achieve the object may include a body provided with a predetermined installation region, a lighting unit provided with a substrate installed in the installation region of the body and a plurality of LED groups mounted on the substrate and generating light having different wavelength ranges, a power supply unit coupled to the body to supply power to the lighting unit and connected to an external power source, and a control module configured to operate at least one LED group selected by an operator among the LED groups, wherein the substrate may extend by a predetermined length, may be configured such that LED chips included in the LED groups are sequentially arranged thereon in a longitudinal direction, and may be formed to be curved according to the installation region.

The substrate may be formed in an arc shape having a predetermined radius centered on a center of the installation region.

It is preferable that the substrate may have one end installed adjacent to the center of the installation region and the other end extending away from the center of the installation region, and may be formed such that the radius increases as the substrate extends away from the center of the installation region.

The body may extend in a vertical direction and may be provided with the installation region on an outer circumferential surface thereof, and the substrate may be formed to helically extend along the outer circumferential surface of the body. The body may include a main body extending in the vertical direction and provided with the installation region on an outer circumferential surface thereof, and a hooking member provided at an upper end portion of the main body such that the main body is hooked to a mounting object.

The body may include a support base, and a main body installed on the support base, extending upward from the support base by a predetermined length, and provided with the installation region on an outer circumferential surface thereof. The main body may include a plurality of unit blocks sequentially arranged in the vertical direction and a plurality of distance adjusting members installed between the unit blocks to adjust a spacing distance between adjacent unit blocks, and the substrate may include be made of a flexible material, and may have one end fixed to an uppermost one among the unit blocks and the other end fixed to a lowermost one among the unit blocks.

The unit block may have a plurality of spacing protrusions formed to protrude on an outer circumferential surface thereof facing the substrate so as to support the substrate to be spaced apart and to prevent the substrate from being in close contact.

Meanwhile, the multi-channel bulb and bar-type lighting lamp for crop growth according to the present invention may further include a blowing member installed at an upper end or a lower end of the main body to forcibly blow external air into a space between the unit block and the substrate, wherein the substrate may have a guide protrusion formed to extend in a longitudinal direction on a side surface thereof facing the unit block so as to guide the external air forcibly blown by the blowing member.

The main body may be formed such that an outer diameter thereof increases or decreases from an upper end toward a lower end, and may have a reflective layer coated on an outer circumferential surface thereof to reflect light generated from the lighting unit.

### Advantageous Effects

A multi-channel bulb and bar-type lighting lamp for crop growth according to the present invention has an advantage in that, since a plurality of LED groups emitting light of various wavelength ranges can be selectively operated to provide light to cultivated plants, it is possible to rapidly respond to various situations depending on plant growth.

### DESCRIPTION OF DRAWINGS

FIG. 1 is a perspective view of a multi-channel bulb and bar-type lighting lamp for crop growth according to the present invention,

FIG. 2 is a partial cross-sectional view of the multi-channel bulb and bar-type lighting lamp for crop growth of FIG. 1,

FIG. 3 is an exemplary view of a lighting unit of the multi-channel bulb and bar-type lighting lamp for crop growth of FIG. 1,

FIG. 4 is a block diagram of a control module of the multi-channel bulb and bar-type lighting lamp for crop growth of FIG. 1,

FIG. 5 is a plan view of the lighting unit of the multi-channel bulb and bar-type lighting lamp for crop growth of FIG. 1,

FIG. 6 is a plan view of a lighting unit according to another embodiment of the present invention,

FIG. 7 is a plan view of a lighting unit according to still another embodiment of the present invention,

FIG. 8 is a perspective view of a multi-channel bulb and bar-type lighting lamp for crop growth according to another embodiment of the present invention,

FIG. 9 is a perspective view of a multi-channel bulb and bar-type lighting lamp for crop growth according to still another embodiment of the present invention,

FIG. 10 is a perspective view of a multi-channel bulb and bar-type lighting lamp for crop growth according to yet another embodiment of the present invention,

FIG. 11 is a perspective view of a multi-channel bulb and bar-type lighting lamp for crop growth according to yet another embodiment of the present invention,

FIG. 12 is a perspective view of a multi-channel bulb and bar-type lighting lamp for crop growth according to yet another embodiment of the present invention,

FIG. 13 is a side view of a multi-channel bulb and bar-type lighting lamp for crop growth according to yet another embodiment of the present invention, and

FIG. 14 is a side view of a multi-channel bulb and bar-type lighting lamp for crop growth according to yet another embodiment of the present invention.

### MODES OF THE INVENTION

Hereinafter, a multi-channel bulb and bar-type lighting lamp for crop growth according to an embodiment of the present invention will be described in detail with reference to the accompanying drawings. Since the present invention may be variously modified and may have various forms, and specific embodiments are illustrated in the drawings and will be described in detail in the specification. However, it should be understood that this is not intended to limit the present invention to a specific disclosed form and includes all changes, equivalents, and substitutions included in the spirit and technical scope of the present invention. Like reference numerals have been used for like components throughout the description of each drawing. In the accompanying drawings, the dimensions of the structures are illustrated enlarged than the actual sizes for clarity of the present invention.

Terms such as first and second may be used to describe various components, but the components should not be limited by the terms. The terms are used only for the purpose of distinguishing one component from another. For example, a first component may be referred to as a second component, and similarly, the second component may also be referred to as the first component without departing from the scope of the present invention.

The terms used in the present application are only used to describe specific embodiments and are not intended to limit the present invention. The singular expression includes the plural expression unless the context clearly dictates otherwise. In the present application, it should be understood that terms such as “include” or “have” are intended to specify that features, numbers, steps, operations, components, parts, or combinations thereof described in the specification are present, but do not preclude the possibility of the presence or addition of one or more other features, numbers, steps, operations, components, parts, or combinations thereof.

Unless defined otherwise, all terms used herein, including technical or scientific terms, have the same meaning as commonly understood by those of ordinary skill in the art to which the present invention pertains. Terms such as those defined in a commonly used dictionary should be construed as having a meaning consistent with the meaning in the context of the related art and should not be construed in an ideal or excessively formal meaning unless explicitly defined in the present application.

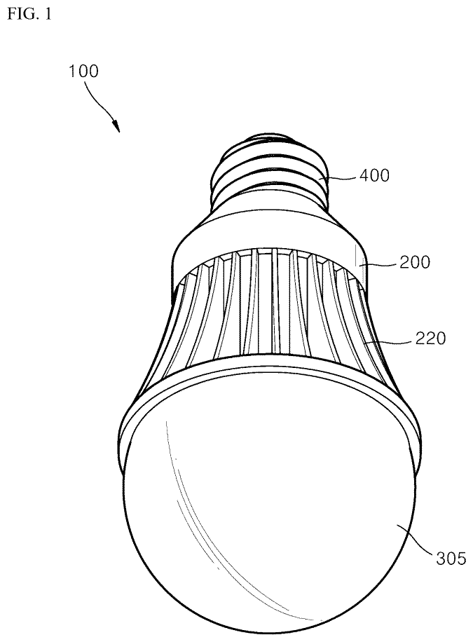

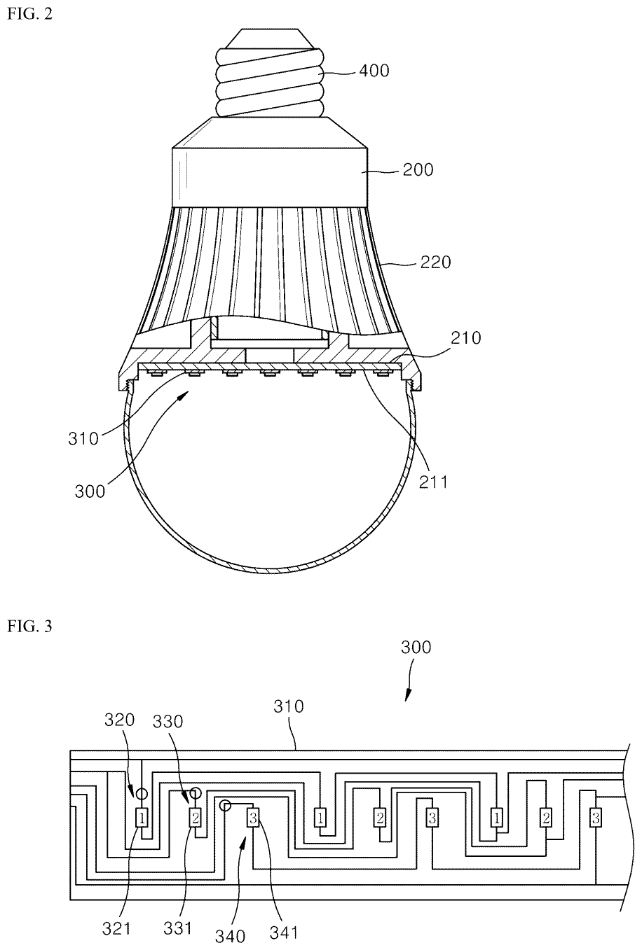

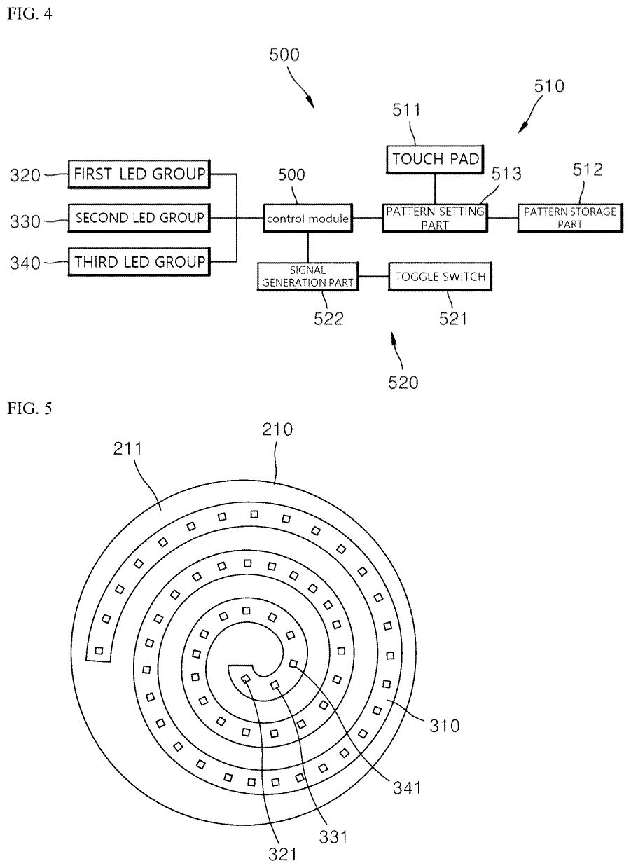

FIGS. 1 to 5 show a multi-channel bulb and bar-type lighting lamp for crop growth 100 according to the present invention.

Referring to the drawings, the multi-channel bulb and bar-type lighting lamp for crop growth 100 may include a body 200 provided with a predetermined installation region 211, a lighting unit 300 provided with a substrate 310 installed in the installation region 211 of the body 200, and first to third LED groups 320, 330, and 340 mounted on the substrate 310 and generating light having different wavelength ranges, a power supply unit 400 coupled to the body 200 to supply power to the lighting unit 300 and connected to an external power source, and a control module 500 configured to operate at least one LED group selected by an operator among the first to third LED groups 320, 330, and 340.

The body 200 may be provided at a lower portion thereof with a mounting part 210 recessed upward to mount the lighting unit 300. The mounting part 210 may be provided at a lower portion thereof with the installation region 211 for mounting the lighting unit 300, and it may be preferable that the installation region 211 is formed in a flat circular shape. The body 200 may have a plurality of heat dissipation fins 220 extending outward to dissipate heat generated from the lighting unit 300.

The substrate 310 may have a predetermined thickness and extends by a predetermined length. Here, since the substrate 310 is a PCB substrate generally used for mounting light emitting diodes such as LED chips, a detailed description thereof will be omitted. Meanwhile, the substrate 310 may be configured such that LED chips included in the first to third LED groups are sequentially arranged thereon in a longitudinal direction, and may be formed to be curved according to the installation region 211.

That is, as shown in the drawings, the substrate 310 may be formed in an arc shape having a predetermined radius centered on a center of the installation region 211. In this case, the substrate 310 may have one end installed adjacent to the center of the installation region 211 and the other end extending away from the center of the installation region 211, and may be formed such that the radius increases as the substrate extends away from the center of the installation region 211. That is, the substrate 310 may be formed in a spiral shape based on the center of the installation region 211.

The first LED group 320 may include a plurality of first LED chips mounted to be spaced apart from each other in the longitudinal direction on the substrate 310. The first LED chips may be formed to emit light of three different wavelength ranges.

Here, light of a first wavelength range of the first LED chips 321 may be monochromatic light having a central wavelength of 380 nm, which is emitted in an amount of 25% to 35% of a total photosynthetic photon flux of the first LED chips 321. The emission spectrum of light of the first wavelength range of the first LED chips 321 may form a sharp needle shape centered on the central wavelength.

Light of a second wavelength range of the first LED chips 321 may have a central wavelength of 450 nm and a wavelength bandwidth of 430 nm to 480 nm, and emits 5% to 15% of the total photosynthetic photon flux of the first LED chips 321. The emission spectrum of light of the second wavelength range of the first LED chips 321 may form a gentle bell-shaped curve centered on the central wavelength.

Light of a third wavelength range of the first LED chips 321, which emits the remainder of the total photosynthetic photon flux of the first LED chips 321, may have a central wavelength of 660 nm and a wavelength bandwidth of 630 nm to 700 nm. The emission spectrum of light of the third wavelength range of the first LED chips 321 may form a gentle bell-shaped curve centered on the central wavelength. Here, the first LED chips 321 may be manufactured by doping a phosphor onto a UV-a emitting LED chip so as to output the light.

The second LED group may include a plurality of second LED chips 331 mounted to be spaced apart from each other in the longitudinal direction on the substrate 310. The second LED chips 331 may be formed to emit light of three different wavelength ranges.

Here, light of a first wavelength range of the second LED chips 331 may be monochromatic light having a central wavelength of 380 nm, which is emitted in an amount of 15% to 25% of a total photosynthetic photon flux of the second LED chips 331. The emission spectrum of light of the first wavelength range of the second LED chips 331 may form a gentle sharp needle shape centered on the central wavelength.

Light of a second wavelength range of the second LED chips 331 may have a central wavelength of 450 nm and a wavelength bandwidth of 430 nm to 480 nm, and emits 15% to 25% of the total photosynthetic photon flux of the second LED chips 331. The emission spectrum of light of the second wavelength range of the second LED chips 331 may form a gentle bell-shaped curve centered on the central wavelength.

Light of a third wavelength range of the second LED chips 331, which emits the remainder of the total photosynthetic photon flux, may have a central wavelength of 730 nm. The emission spectrum of light of the third wavelength range of the second LED chips 331 may form a sharp needle shape centered on the central wavelength.

Here, the second LED chips 331 may be manufactured by pre-doping a nitride-based phosphor, which emits a central wavelength of 680 nm and a final wavelength range limited up to the 700 nm range, onto a BLU LED chip, and then by post-doping a nitride-based phosphor, which emits 660 to 670 nm and a final wavelength range limited up to the 730 nm range, so as to output the light.

The third LED group may include a plurality of third LED chips 341 mounted to be spaced apart from each other in the longitudinal direction on the substrate 310. The third LED chips 341 may be formed such that light of a wavelength range of 630 nm to 700 nm is emitted in an amount of 60% to 70% of a total photosynthetic photon flux. The third LED chips 341 may be formed by doping a nitride-based phosphor onto a blue diode chip that emits light of a wavelength range of 430 nm to 450 nm, such that after doping, the third LED chips 341 may have a central wavelength of 660 nm and a wavelength range of 630 nm to 700 nm.

Here, it may be preferable that the first to third LED chips 321, 331, and 341 are alternately and sequentially arranged along a center line of the longitudinal direction of the substrate 310. In this case, a lighting module including the first to third LED chips 321, 331, and 341 may constitute one unit lighting, and a plurality of lighting modules may be disposed on the substrate 310 in a form of directly connected to each other. Here, the first to third LED chips 321, 331, and 341 may be directly connected to the first to third LED chips 321, 331, and 341, respectively, and may be independently grounded.

As described above, since the substrate 310 in the spiral shape on which the first to third LED chips 321, 331, and 341 may be mounted is installed on the body 200, the plurality of LED groups can be more easily mounted on the body 200, and the operator can easily control the LED groups by the control module 500 described below.

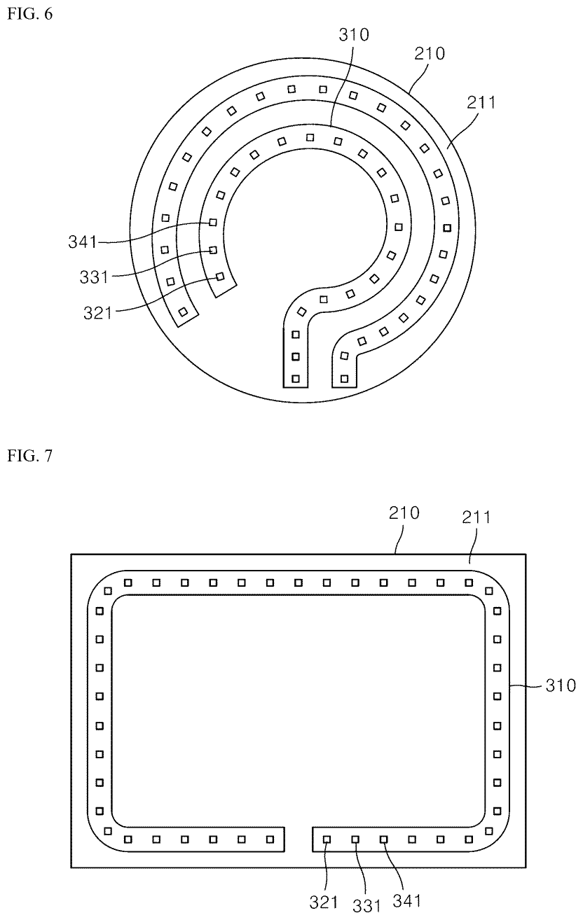

Meanwhile, as shown in FIG. 6, a plurality of lighting units 300 may be installed in the installation region 211 of the body 200. Here, the lighting unit 300 may be formed in a question mark shape having an arc shape with a predetermined radius about the center of the installation region 211. In addition, as shown in FIG. 7, the lighting unit 300 may extend along an edge of the installation region 211. Here, the installation region 211 may be formed in a quadrangular shape, and the substrate 310 may extend to be curved in a quadrangular shape corresponding to the installation region 211.

In addition, the lighting unit 300 may further include a cover member 305 installed at a lower portion of the body 200 so as to cover the mounting part 210 of the body 200. The cover member 305 may be made of a transparent light-transmissive material to transmit light of the lighting unit 300, and may be preferably formed in a downwardly convex hemispherical shape.

The power supply unit 400 may be provided at an upper portion of the body 200 to supply power to the lighting unit 300 and connected to an external power source, and it may be preferable to apply the same standard as a socket of an existing incandescent bulb to the power supply unit 400 so as to be connectable to a general incandescent bulb connector. Meanwhile, the power supply unit 400 is not limited thereto and any power supply means capable of supplying power to the lighting unit 300 installed in the body 200 may be applied.

The control module 500 may include a first switch unit 510 configured to allow the operator to input a first operation signal for operating the LED groups through touch manipulation, a second switch unit 520 provided with a lever to be manipulated by the worker, and a controller 530 configured to control the lighting unit 300 according to the first operation signal or the second operation signal.

The first switch unit 510 may be configured to allow the operator to input the first operation signal for operating the LED groups by touch manipulation, and may include an on/off power touch pad 511, a pattern storage part 512, and a pattern setting part 513.

The on/off power touch pad 511 may be provided at a position adjacent to the lighting unit 300 so that the operator may perform touch manipulation. Since the on/off power touch pad 511 is a recognition means such as a touch screen generally used to recognize a touch of an operator's finger, a detailed description thereof will be omitted.

The pattern storage part 512 may store a plurality of light emitting patterns regarding operation of the LED groups of the lighting unit 300. The light emitting patterns may include a light emitting pattern in which the first LED group 320 is solely operated, a light emitting pattern in which the second LED group 330 is solely operated, a light emitting pattern in which the third LED group 340 is solely operated, a light emitting pattern in which the first and second LED groups 320 and 330 are operated, a light emitting pattern in which the first and third LED groups 320 and 340 are operated, a light emitting pattern in which the second and third LED groups 330 and 340 are operated, and a light emitting pattern in which the first to third LED groups 320, 330, and 340 are operated.

The pattern setting part 513 may generate the first operation signal so that the LED groups of the lighting unit 300 are operated in one of the light emitting patterns stored in the pattern storage part 512, and transmit the first operation signal to the controller 530. Here, when a touch of the operator is input to the on/off power touch pad 511, the pattern setting part 513 may generate the first operation signal so that the light emitting pattern applied to the LED groups among the light emitting patterns is sequentially changed according to a preset operation order. For example, when a touch of the operator is first recognized on the on/off power touch pad 511, the pattern setting part 513 may generate the first operation signal corresponding to the light emitting pattern in which the first LED group is solely operated and when the touch of the operator is again recognized on the on/off power touch pad 511, the pattern setting part 513 may generate the first operation signal corresponding to the light emitting pattern in which the second LED group is solely operated. In addition, when the touch of the operator is recognized again on the on/off power touch pad 511, the pattern setting part 513 may generate the first operation signal corresponding to the light emitting pattern in which the third LED group 340 is solely operated, and when the touch of the operator is further recognized, the pattern setting part 513 may generate the first operation signal corresponding to the light emitting pattern in which the first and second LED groups are operated. And, when the touch of the operator is further recognized on the on/off power touch pad 511, the pattern setting part 513 may generate the first operation signal corresponding to the light emitting pattern in which the first and third LED groups 320 and 340 are operated, and when the touch of the operator is again recognized on the on/off power touch pad 511, the pattern setting part 513 may generate the first operation signal corresponding to the light emitting pattern in which the second and third LED groups 330 and 340 are operated. In addition, when the touch of the operator is recognized again on the on/off power touch pad 511, the pattern setting part 513 may generate the first operation signal corresponding to the light emitting pattern in which the first to third LED groups 320, 330, and 340 are operated, and when the touch of the operator is further recognized on the on/off power touch pad 511, the pattern setting part 513 may generate the first operation signal corresponding to the light emitting pattern in which the first LED group is operated.

In this case, the operation order of the light emitting patterns is not limited thereto, but it may preferable that the LED groups of a wavelength range suitable for the growth of the plant to be cultivated are set by an expert, and that the LED groups are sequentially set according to a growth period of the plant. Therefore, even when the operator is not an expert, the operator may sequentially touch the on/off power touch pad 511 to operate the lighting unit 300 such that light of a wavelength range corresponding to the growth state of the plant is irradiated.

The second switch unit 520 may include a toggle switch 521 and a signal generation part 522 configured to generate the second operation signal for the operation of the lighting unit 300 according to operation of the toggle switch 521.

The toggle switch 521 may be provided with a lever to be manipulated by the operator, and the lever may be formed to be set to any one of a plurality of setting positions or a neutral position by the operator's manipulation. Here, since the toggle switch 521 is a generally used toggle switch capable of positioning the lever at any one of an up position, a down position, and a neutral position, a detailed description thereof will be omitted. In this case, a plurality of toggle switches 521 may be provided according to the number of LED groups of the lighting unit 300.

The signal generation part 522 may generate the second operation signal such that the LED groups operate in different operation patterns according to a position of the lever set by the operator. Here, the operation patterns may include a pattern in which the first LED group 320 is solely operated, a pattern in which the second LED group 330 is solely operated, a pattern in which the third LED group 340 is solely operated, a pattern in which the first and second LED groups 320 and 330 are operated, a pattern in which the first and third LED groups 320 and 340 are operated, a pattern in which the second and third LED groups 330 and 340 are operated, and a pattern in which the first to third LED groups 320, 330, and 340 are operated.

For example, when the lever is set to any one of the setting positions, the signal generation part 522 may generate the second operation signal corresponding to the operation pattern in which the first LED group 320 is solely operated, and when the lever is set to another one of the set positions, the signal generation part 522 may generate the second operation signal corresponding to the operation pattern in which the third LED group 340 is solely operated. Here, the operation pattern may be set by the operator.

The controller 530 may control the lighting unit 300 according to the first operation signal or the second operation signal provided from the first and second switch units. In this case, when the lever of the toggle switch 521 is set to the neutral position, the controller 530 may control the operation of the LED groups according to the first operation signal provided from the first switch unit 510. In addition, when the lever of the toggle switch 521 is set to the setting positions, the controller 530 may control the operation of the LED groups according to the second operation signal provided from the second switch unit 520.

That is, when the lever of the toggle switch 521 is set to the neutral position, the operator may sequentially change the light emitting patterns of the lighting unit 300 by using the on/off power touch pad 511 according to the preset operation order, and when the lever of the toggle switch 521 is set to the setting positions other than the neutral position, the controller 530 may control the lighting unit 300 such that the LED group set in the corresponding setting position is operated.

As configured above, the multi-channel bulb and bar-type lighting lamp for crop growth 100 according to the present invention has an advantage in that since a plurality of LED groups emitting light of various wavelength ranges may be selectively operated to provide light to cultivated plants, it is possible to rapidly respond to various situations depending on plant growth.

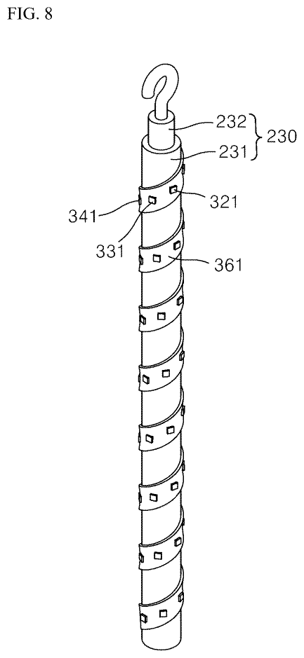

Meanwhile, FIG. 8 shows a body 230 according to another embodiment of the present invention.

In the drawing, elements having the same functions as those shown in the previous drawings are denoted by the same reference numerals.

Referring to the drawing, the body 230 may extend in a vertical direction, may be provided with the installation region 211 on an outer circumferential surface thereof, and may include a main body 231 and a hooking member 232.

The main body 231 may have a predetermined outer diameter and may be formed in a cylindrical shape extending in the vertical direction. The main body 231 may be provided with the installation region 211 so that the substrate 361 of the lighting unit 300 may be installed on an outer circumferential surface thereof. Here, the substrate 361 may be formed to helically extend to surround the outer circumferential surface of the main body 231, that is, the installation region 211. In this case, it may be preferable that the substrate 361 is made of a flexible material having a predetermined elasticity.

The hooking member 232 may be formed at an upper end portion of the main body 231 such that the main body 231 may be hooked to a mounting object. Here, the mounting object may be a branch of a cultivated plant or an upper end portion of a support. It may be preferable that the hooking member 232 is formed such that an upper end thereof is curved in a ring shape.

Here, although not shown in the drawing, the power supply unit 400 may be installed in the main body 231, may be connected to an external power source, and may supply power to the LED groups of the lighting unit 300. The power supply unit 400 is not limited thereto, but any supply means that may provide power supplied from the external power source to the LED groups of the lighting unit 300 may be applied.

As configured above, since the body 230 is hooked to the mounting object, installation may be facilitated, and since the substrate 361 is helically wound around the outer circumferential surface of the main body 231 extending in the vertical direction, light may be uniformly irradiated to cultivated crops.

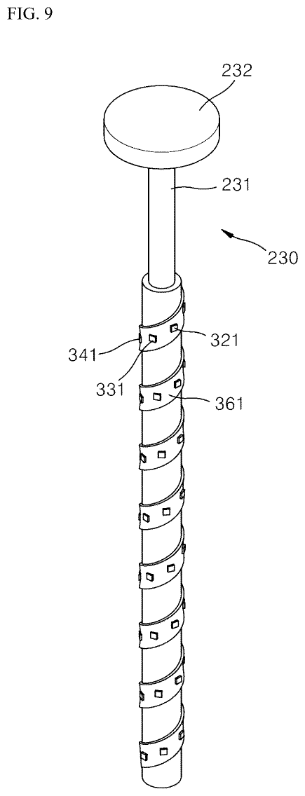

Meanwhile, as shown in FIG. 9, the hooking member 232 may be formed in a plate shape having a predetermined thickness rather than a ring shape so as to be hooked to a ceiling surface of a building. Here, it is preferable that the hooking member 232 may be formed to have an area larger than a cross-sectional area of the main body 231. The hooking member 232 may be fixed by bolting to the ceiling surface of the building.

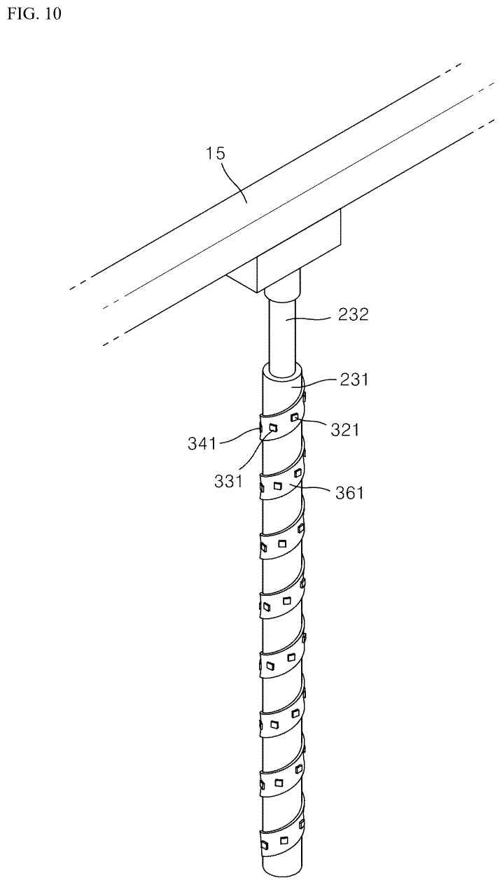

In addition, as shown in FIG. 10, the hooking member 232 may also be formed to be hooked to a rail bar 15 installed on the ceiling surface of the building. The rail bar 15 may be fixed to the ceiling surface of the building and may extend by a predetermined length. In addition, the rail bar 15 may be provided with a rail (not shown) extending in a longitudinal direction on a lower surface thereof so that the hooking member 232 may be movably coupled. A power line connectable to the power supply unit may be installed inside the rail bar 15. The hooking member 232 may be movably installed along the rail of the rail bar 15, and the power supply unit may be installed inside the hooking member 232. In this case, the power supply unit installed inside the hooking member 232 may be connected to the power line of the rail bar 15 to supply power to the lighting unit.

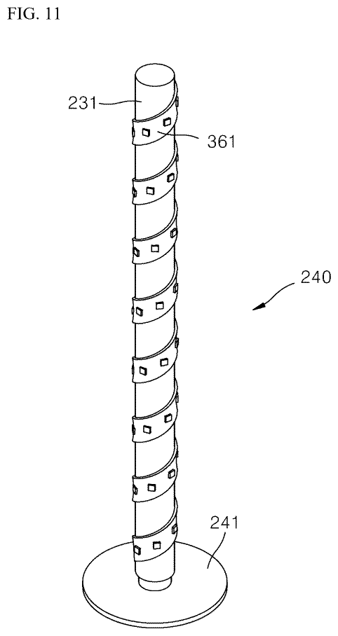

Meanwhile, FIG. 11 shows a body 240 according to another embodiment of the present invention.

Referring to the drawing, the body 240 may include a support base 241 instead of the hooking member 232.

The support base 241 may be installed at a lower end portion of the main body 231 and may be formed to have an area larger than the cross-sectional area of the main body 231 so as to stably support the main body 231 with respect to the ground. Meanwhile, although not shown in the drawing, a plurality of moving wheels may be installed at a lower portion of the support base 241 so as to easily move the body 240.

As described above, since the body 240 is provided with the support base 241 at the lower end of the main body 231, the main body 231 may be more easily set in an upright state in the vicinity of cultivated plants.

Meanwhile, although not shown in the drawing, the main body 231 may be formed in a conical shape such that the outer diameter thereof increases from an upper end toward a lower end. Here, the main body 231 may be provided with the installation region 211 on the outer circumferential surface thereof such that the substrate 361 may be helically set. In addition, it may be preferable that the main body 231 is coated with a reflective layer on the outer circumferential surface thereof to reflect light generated from the lighting unit 300. It may be preferable that the coating layer is formed to cover the outer circumferential surface of the main body 231.

As described above, since the outer circumferential surface of the main body 231 on which the lighting unit 300 is installed may be formed to be inclined, the LED chips of the lighting unit 300 may be set to face upward by the inclined outer circumferential surface of the main body 231, so that even when the body 240 is installed below cultivated plants, light of the lighting unit 300 may be easily irradiated to the cultivated plants, and part of the light of the lighting unit 300 may be reflected toward the cultivated plants by the coating layer so as to uniformly irradiate the cultivated plants with light.

Meanwhile, although not shown in the drawing, the main body 231 may be formed such that the outer diameter thereof decreases from the upper end toward the lower end, without being limited thereto. The main body 231 may be set such that the lighting unit 300 irradiates light easily to the cultivated plants by the inclined outer circumferential surface even when the body 240 is installed above the cultivated plants.

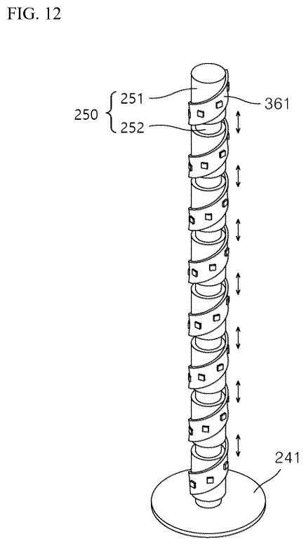

Meanwhile, FIG. 12 shows a main body 250 according to another embodiment of the present invention.

Referring to the drawing, the main body 250 may include a plurality of unit blocks 251 sequentially arranged in a vertical direction, and a plurality of distance adjusting members 252 installed between the unit blocks 251 to adjust a spacing distance between adjacent unit blocks 251.

The unit block 251 may be formed in a cylindrical shape extending in the vertical direction. The plurality of unit blocks 251 may be supported by the distance adjusting members 252 and sequentially arranged in the vertical direction. The installation region 211 on which the substrate 361 of the lighting unit 300 is installed may be provided on an outer circumferential surface of the unit block 251.

The distance adjusting member 252 may each be provided between upper and lower ends of the adjacent unit blocks 251, and an actuator such as a hydraulic cylinder or a screw jack, in which a vertical length may be extendable and contractible, may be applied. The distance adjusting member 252 may increase or decrease the spacing distance between the unit blocks 251 to adjust a length of the main body 250.

In this case, the substrate 361 may be made of a flexible material having predetermined elasticity and may helically extend so as to surround the outer circumferential surfaces of the unit blocks 251. Here, the substrate 361 may have one end fixed to an uppermost one of the unit blocks 251 and the other end fixed to a lowermost one of the unit blocks 251.

Meanwhile, it may be preferable that, except for the one end and the other end that are fixed to the unit blocks 251, the remaining portion of the substrate 361 is supported in an unfixed state so as to be separated from the unit blocks 251. In addition, it may be preferable that the substrate 361 may be set to be helically wound with an outer diameter larger than an outer diameter of the unit blocks 251 so as not to be in close contact with the unit blocks 251, thereby being easily deformable when the unit blocks 251 are elevated or lowered.

As described above, since the main body 250 is formed such that a vertical length thereof is extendable and contractible, an irradiation position of light of the lighting unit 300 may be adjusted according to a size or a growth state of the cultivated plant, thereby creating a growth environment suitable for growth of the cultivated plant.

Meanwhile, although not shown in the drawing, the uppermost unit block 251 or the lowermost unit block 251 among the unit blocks 251 may further include a base member installed at an end portion of the distance adjusting member 252, a rotating member rotatably installed on the base member and having one end or the other end of the substrate 361 fixed on an outer circumferential surface thereof, and a driving module configured to rotate the rotating member. Here, the rotating member may be installed on the base member so as to rotate about a central axis extending in the vertical direction such that the substrate 361 may be wound to be in close contact with the main body 250 or unwound to be spaced apart therefrom. The driving module may include an electric motor installed on the base member to rotate the rotating member. When the operator elevates or lowers the unit blocks 251, the operator may operate the driving module to rotate the rotating member by a predetermined angle such that the substrate 361 is unwound from the main body 250, and when the elevating or lowering of the unit blocks 251 is completed, the operator may rotate the rotating member in a reverse direction by a predetermined angle such that the substrate 361 is wound on the unit blocks 251 to be in close contact with the outer circumferential surface of the main body 250. Therefore, it is possible to prevent the substrate 361 in close contact with the main body 250 from being damaged by the elevation or lowering of the unit blocks 251.

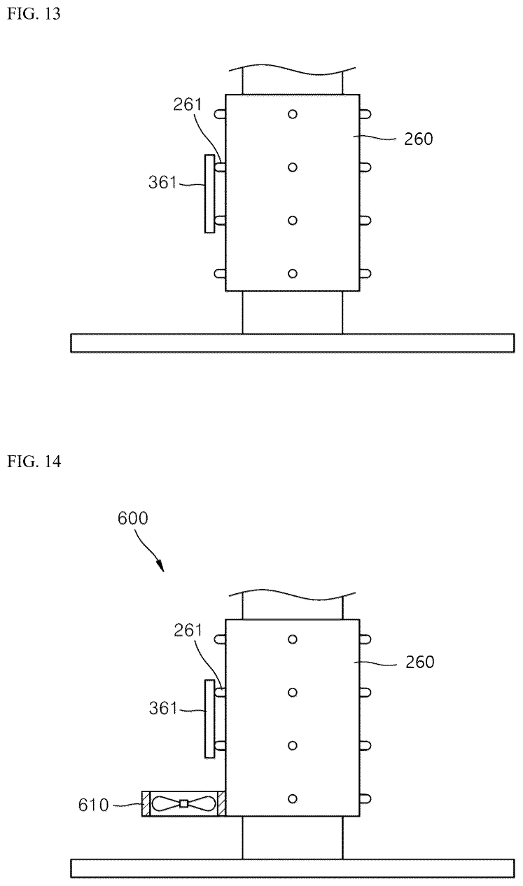

Meanwhile, FIG. 13 shows a unit block 260 according to another embodiment of the present invention.

Referring to the drawing, the unit block 260 may have a plurality of spacing protrusions 261 formed to protrude on an outer circumferential surface thereof facing the substrate 361 so as to support the substrate 361 to be spaced apart and to prevent the substrate 361 from being in close contact.

The spacing protrusions 261 may be formed to protrude outward on the outer circumferential surface of the unit block 260. It may be preferable that the spacing protrusions 261 are formed to be spaced apart from each other in a circumferential direction and a vertical direction of the unit block 260. In this case, the spacing protrusions 261 may be formed on the remaining unit blocks 260 except for the uppermost unit block 260 and the lowermost unit block 260 to which the substrate 361 is fixed, among the unit blocks 260.

Since the substrate 361 may be supported to be spaced apart from the unit block 260 by the spacing protrusions 261, heat generated from the lighting unit 300 may be prevented from being transferred to the unit block 260, thereby preventing the main body 250 from being deformed by the heat of the lighting unit 300.

Meanwhile, FIG. 14 shows a multi-channel bulb and bar-type lighting lamp for crop growth 600 according to another embodiment of the present invention.

Referring to the drawing, the multi-channel bulb and bar-type lighting lamp for crop growth 600 may further include a blowing member 610 installed at a lower end of the main body 250 to forcibly blow external air into a space between the unit block 260 and the substrate 361. The blowing member 610 may be applied as a blowing fan installed on an outer circumferential surface of the lowermost unit block 260 among the unit blocks 260 to forcibly blow the external air upward. Here, the blowing member 610 is not limited thereto, but may be installed at an upper end of the main body 250 to blow the external air downward.

In this case, although not shown in the drawing, the substrate 361 may have guide protrusions formed to extend in a longitudinal direction on a side surface thereof facing the unit block 260 so as to guide the external air forcibly blown by the blowing member 610. The guide protrusions may be formed to protrude from the side surface of the substrate 361 toward the unit block 260.

Since the external air may be forcibly blown into the space between the substrate 361 and the unit block 260 through the blowing member 610 and may flow along an inner surface of the substrate 361 along the guide protrusions, heat generated from the LED groups may be easily dissipated, thereby preventing the LED chips of the LED groups from being defective due to the heat.

The description of the suggested embodiments is provided so that those skilled in the art of the present invention may use or practice the present invention. Various modifications to these embodiments will be apparent to those skilled in the art of the present invention, and the general principles defined herein may be applied to other embodiments without departing from the scope of the present invention. Therefore, the present invention is not limited to the embodiments suggested herein, but should be construed in the widest scope consistent with the principles and novel features suggested herein.

1. A multi-channel bulb and bar-type lighting lamp for crop growth, comprising:
a body provided with a predetermined installation region;
a lighting unit provided with a substrate installed in the installation region of the body and a plurality of LED groups mounted on the substrate and generating light having different wavelength ranges;
a power supply unit coupled to the body to supply power to the lighting unit and connected to an external power source; and
a control module configured to operate at least one LED group selected by an operator among the LED groups;
wherein
the substrate extends by a predetermined length, is configured such that LED chips included in the LED groups are sequentially arranged thereon in a longitudinal direction, and is formed to be curved according to the installation region.

2. The multi-channel bulb and bar-type lighting lamp for crop growth according to claim 1, wherein
the substrate is formed in an arc shape having a predetermined radius centered on a center of the installation region.

3. The multi-channel bulb and bar-type lighting lamp for crop growth according to claim 2, wherein
the substrate has one end installed adjacent to the center of the installation region and the other end extending away from the center of the installation region, and is formed such that the radius increases as the substrate extends away from the center of the installation region.

4. The multi-channel bulb and bar-type lighting lamp for crop growth according to claim 1, wherein
the body extends in a vertical direction and is provided with the installation region on an outer circumferential surface thereof, and
the substrate is formed to helically extend along the outer circumferential surface of the body.

5. The multi-channel bulb and bar-type lighting lamp for crop growth according to claim 3, wherein
the body comprises:
a main body extending in the vertical direction and provided with the installation region on an outer circumferential surface thereof; and
a hooking member provided at an upper end portion of the main body such that the main body is hooked to a mounting object.

6. The multi-channel bulb and bar-type lighting lamp for crop growth according to claim 3, wherein the body comprises:
a support base; and
a main body installed on the support base, extending upward from the support base by a predetermined length, and provided with the installation region on an outer circumferential surface thereof.

7. The multi-channel bulb and bar-type lighting lamp for crop growth according to claim 5, wherein the main body comprises:
a plurality of unit blocks sequentially arranged in the vertical direction; and
a plurality of distance adjusting members installed between the unit blocks to adjust a spacing distance between adjacent unit blocks, and
the substrate is made of a flexible material, and has one end fixed to an uppermost one among the unit blocks and the other end fixed to a lowermost one among the unit blocks.

8. The multi-channel bulb and bar-type lighting lamp for crop growth according to claim 7, wherein
the unit block has a plurality of spacing protrusions formed to protrude on an outer circumferential surface thereof facing the substrate so as to support the substrate to be spaced apart and to prevent the substrate from being in close contact.

9. The multi-channel bulb and bar-type lighting lamp for crop growth according to claim 8, further comprising
a blowing member installed at an upper end or a lower end of the main body to forcibly blow external air into a space between the unit block and the substrate,
wherein
the substrate has a guide protrusion formed to extend in a longitudinal direction on a side surface thereof facing the unit block so as to guide the external air forcibly blown by the blowing member.

10. The multi-channel bulb and bar-type lighting lamp for crop growth according to claim 5, wherein
the main body is formed such that an outer diameter thereof increases or decreases from an upper end toward a lower end, and has a reflective layer coated on an outer circumferential surface thereof to reflect light generated from the lighting unit.
